(19) United States
(12) Patent Application Publication
(10) Pub. No.: US 2003/0212710 A1
(43) Pub. Date: Nov. 13, 2003

(54) System for tracking activity and delivery of advertising over a file network

(76) Inventor: Michael J. Guy, Studio City, CA (US)

Correspondence Address: PERKINS COIE LLP, POST OFFICE BOX 1208, SEATTLE, WA, 98111-1208, US

(21) Appl. No.: 10/400,889

(22) Filed: Mar. 27, 2003

Related U.S. Application Data
(60) Provisional application No. 60/369,038, filed on Mar. 27, 2002.

(51) Int. Cl. G06F 7/00

(52) U.S. Cl. 707/104.1

(57) ABSTRACT

In a system for tracking activity and delivering advertising over a computer network, the popularity of electronic files is tracked utilizing a plug-in to a system or network, in particular, a file-trading or peer-to peer network. Once the statistical data are obtained, they are stored in a database, and can then be retrieved and compiled and summarized in textual or graphical format. Additionally, incoming file requests to the system are intercepted and demographically appropriate advertising is sent to the requester.

This application claims the benefit of U.S. Provisional Application Serial No. 60/369,038 filed Mar. 27, 2002, which is hereby incorporated by reference as if fully set forth herein.

### FIELD OF THE INVENTION

The present invention relates to computer networks. More particularly, this invention pertains to a system for tracking activity and delivering advertising over a computer network.

### BRIEF DESCRIPTION OF THE DRAWINGS

FIG. 1 is a basic block diagram of the system of the invention engaged to a file trading/sharing network;

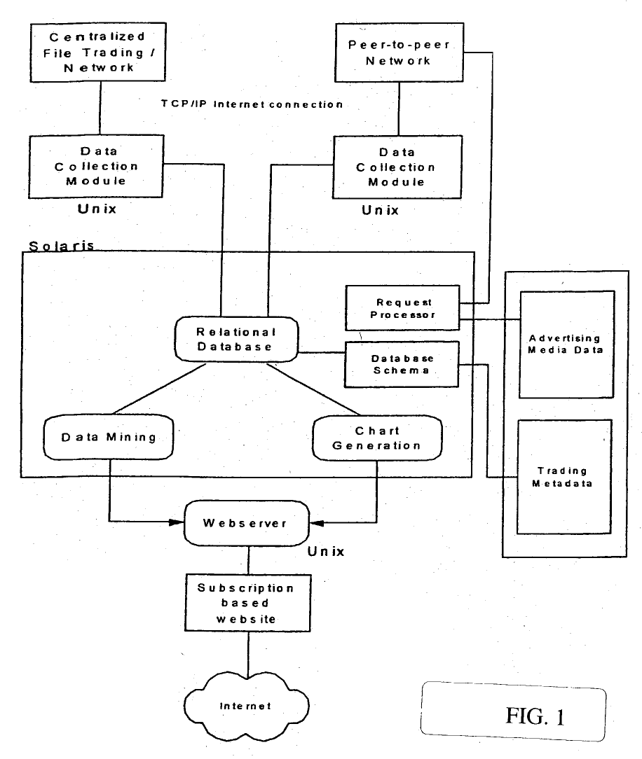

FIG. 2 is a detailed block diagram of the collection system of the invention;

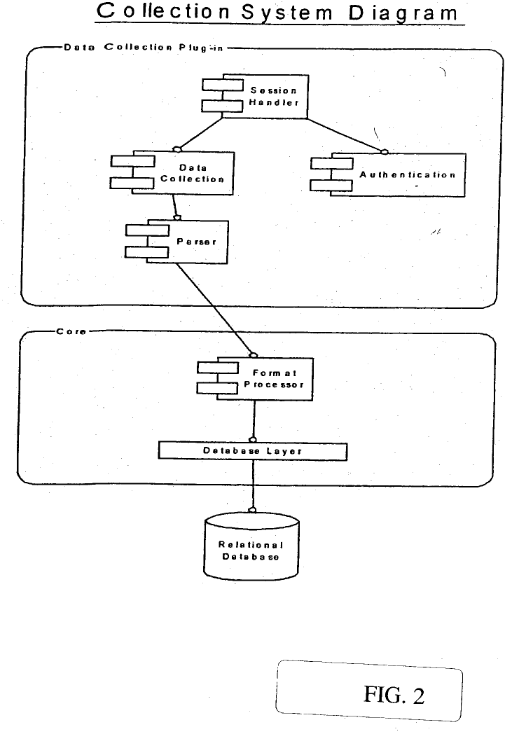

FIG. 3 is a detailed block diagram of the data retrieval module of the invention;

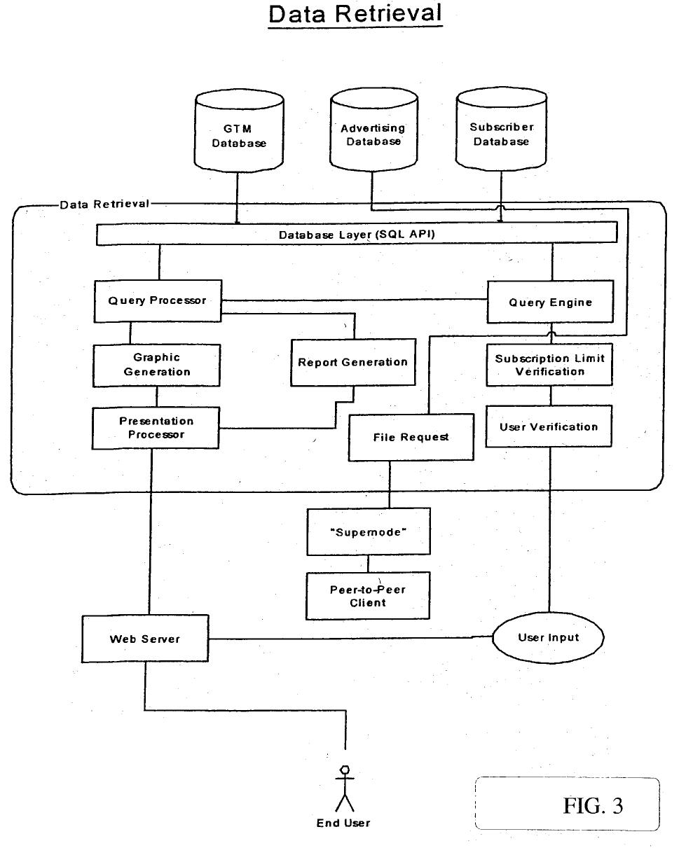

FIG. 4 is a detailed diagram for illustrating the data mining process of a system in accordance with the invention;

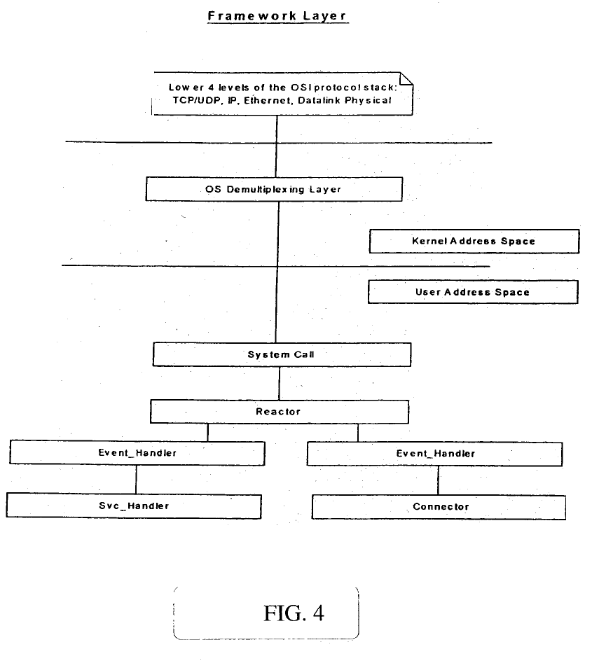

FIG. 5 is a detailed diagram of the application layer portion of the data mining process of the preceding figure; and

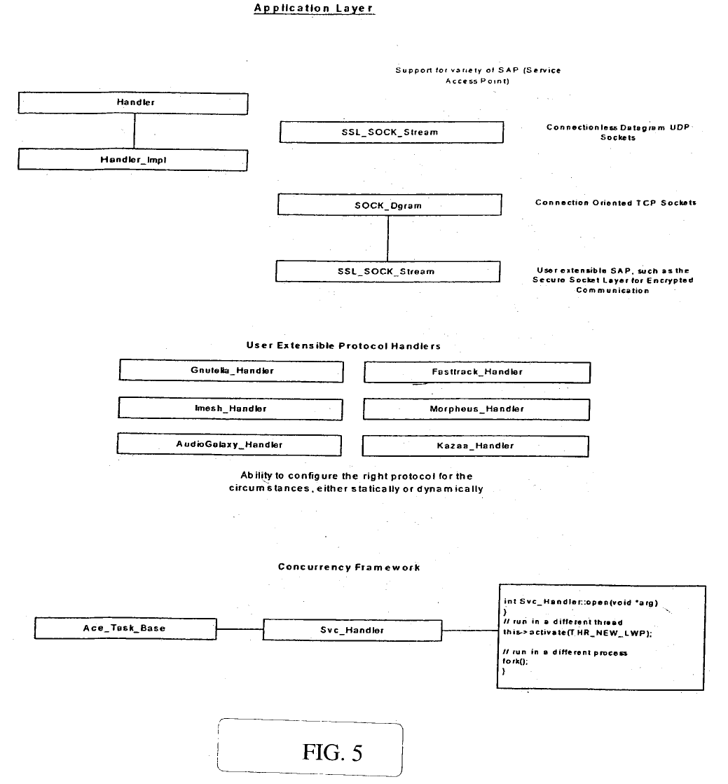

FIG. 6 is a detailed diagram of the protocol communication layer of the data mining process of FIG. 4.

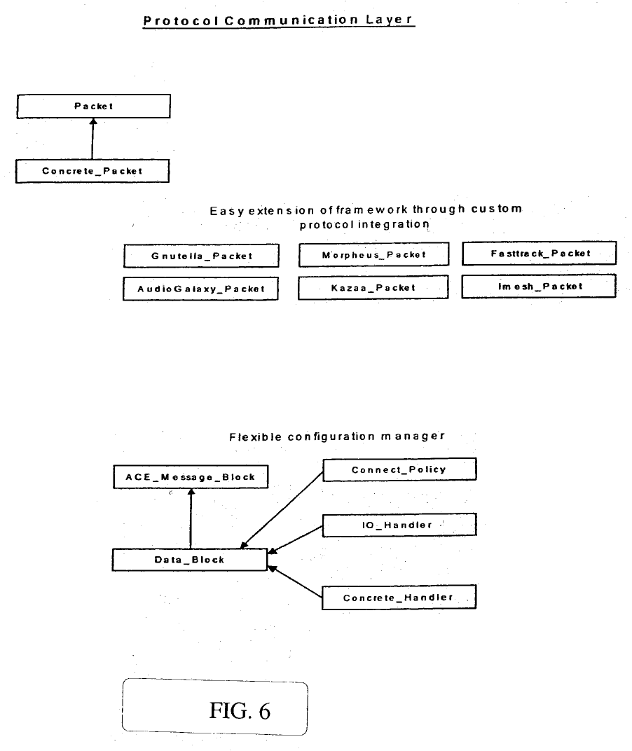

### A BRIEF DESCRIPTION OF THE GTM SYSTEM

A method and apparatus for tracking activity and delivering advertising over a computer network, in particular; music, movies and software, over peer-to-peer networks and Napster like networks. A method and apparatus for the dissemination of promotional content via the fulfillment of an electronic file request over peer-to-peer or Napster like networks. A database containing information regarding the popularity of traded electronic files throughout the network (Internet).

Abstract

A preferred embodiment of the invention provides a tracking method (and corresponding apparatus) for monitoring the trading of electronic files via the file trading and peer-to-peer networks, including but not limited to Napster like networks.

A preferred embodiment of the invention provides a method and apparatus for tracking decentralized networks such as peer-to-peer networks based on their specific protocols utilizing a plug-in to the system. In accordance with a preferred embodiment, the application plug-in is used with the application to make the determination of a particular file's popularity and/or number of users who have downloaded a particular file that has been traded over a computer network. Tracking the transfer of electronic files over a file-trading network is accomplished by introducing a polymorphic behavioral protocol into the current protocol stack of the target file-trading network.

A preferred embodiment of the invention provides a method and corresponding apparatus for creating a database to be used as a recommendation engine for industries including but not limited to the software industry, movies industry, recording industries and/or copyright holders in general who have a vested interest in analysis of this metadata. The data can then be separated by desired categories and displayed via a computer terminal or website for analysis. A preferred embodiment of the invention provides a method and corresponding apparatus for delivering advertising over a computer network. This is accomplished by the interception of incoming file requests and the subsequent fulfillment of said requests by the substitution of demographicaly appropiate advertising. At critical mass the GTM system's peer to peer module achieves “Super-node” status which positions itself at the core of the target network.

History of the Invention

Incorporated in May 1999, the Napster file-trading network marked a new era—unrestricted large scale file trading over the Internet.

As an example, prior to Napster the recording industry collectively, had been able to fully control the propagation of music and the collection of revenues generated by its propagation. The introduction of the Napster software allowed computer users across the world to copy music—be it copyrighted or not—to their hard drives and then trade that music with any other member of the Napster community. This unfettered trading alarmed the recording industry greatly, which saw it as theft of copyrighted material that previously had only been available to consumers via over-the-counter purchase. The estimated revenue losses were several billion dollars, based on peak Napster membership of 80 million registered users (May 2001) and an estimated peak of 2.8 billion song files traded per month using the Napster software.

Legal moves by the recording industry ultimately succeeded in silencing Napster but once a technology is developed there is no going back. Other Napster-like file-trading networks were established, and new technology was developed which deviated from the centralized network model utilized by Napster. Instead of linking via a central host, users are connected in a loosely-distributed peer-to-peer network with their computers acting as ‘servlets’, serving up files stored on their hard drives to any other user requesting that file, and also acting as a client to request and download files stored on other peers within the network. Gnutella is the most prominent example of this, boasting a vast collection of applications that execute in Win32 and Unix environments, allowing the trading of many different forms of copyrighted material including but not limited to music, movies and software.

These industries are facing continued escalation in the number of file-trading networks and the number of users of those networks, and are prior to this invention, popularity of music has been made available only in publications such as Billboard Magazine which the music industry has relied on greatly and Variety Magazine which has been one of the ground distributed publication for the motion picture industry. In the software distribution environment there is no current standard venue for the publication of popularity of unauthorized trades of software. Therefore the need exists for a venue of presentation to make the data available to all the industries affected by the continued escalation of this file-trading phenomenon. Furthermore, the recording industry and other affected industries who collectively suffer from the mass dissemination of what had been “controlled assets” continue to seek relief or to attach revenue to mitigate their losses. By returning a commercial advertisement to fulfill a request that would have been fulfilled with an unauthorized electronic file, promotion takes the place of lost revenue. The system of the invention also makes use of it's resources to act as a filter and a countermeasure to a party seeking to slow down the unauthorized trading of these files by “out-trading” the traders. By flooding the known propagation channels with substitutions for requested content, one could suggest that a record label, for example, could be free to promote their artists new record for a limited period of time. Simply put, these industries need this data and it is not available in the prior art. The system of the invention provides a delivery chain and a venue for the dissemination of advertisement via an electronic file. What is unique and important to mention, is not that an advertisement is propagated on the computer network, but the unique way that it is delivered. The development of Internet-based file trading has had additional impact on industries that are based on ‘traditional’ retail sales beyond the loss of revenue and its effect on capital availability for future products. An example of these consequences is the deprivation of indices by demographic or popularity.

These industries have traditionally required marketing and promotion in order to achieve revenue targets and maximize market penetration, but the presently anonymous nature of file trading makes unavailable to the relevant industries of the necessary information to create and implement strategies to sell their products. Not only do they need to secure lost revenue, they need to reach the file traders in order to market their products, as well as to complete the demographic picture of who their would-be customers are and what products would appeal to them. While securing revenues from Internet-based file trading is the first step, it is only the first step in managing this new method of product distribution and promotion, which will only continue to increase its market share over the years to come.

Prior Technology

A description of the prior art relates directly to the trading of electronic files on a computer network. More specifically, the trading of electronic files via file-sharing networks and/or peer-too-peer networks. A description of the prior art relates directly to the propagation of advertising via an electronic file over a computer network, more specifically the network known as the Internet. The system of the invention relates directly to centralized and decentralized file-trading networks. This invention relates directly to the trading of electronic files over a computer network, commonly referred to as “file-trading” or “peer-to-peer” networks. The system of the invention is therefore the only known art at this time.

Deficiency in Prior Technology

A deficiency in the prior art relates to the need to provide statistical data tracking and analysis for the motion picture, music and software industries who are affected by the mass dissemination or “digital cloning” or propagation of electronic files that are being traded over a computer network. A deficiency in the prior art is the need for statistical data tracking and analysis with the intent to provide a method and corresponding apparatus to provide a determination of royalties that may be due based on the outcome of litigation that may or may not have authority in a given jurisdiction. At this time, the system of the invention could provide a solution providing the work product of the system of the invention were to be certified in that jurisdiction by an authority in that jurisdiction. A deficiency in the prior art is that at this time there is no known method for certification or proof of propagation to show copyright infringement.

System of the Invention (Description of Diagram 1)

Centralized File Trading Network

Description

A target segment and the source of the data for the system of the invention. A “pivot-point” where the peer is connected to other peers. Some of the properties include, but are not limited to:

Specific files, such as (music, movies, applications).

Detailed information on certain internet properties, such as IP address and name registered at ARIN Whois in certain instances.

Geographical location. The geographical location can be determined when a static IP address is used to connect to the computer network In some instances a dynamic IP address can also be geographically determined if reverse authority has been given or if the carrier (upstream) has registered that information.

Actual content (e.g. Music, applications, movies, text)

Peer-to-Peer File Trading Network

Description

Another target segment and source of the data for the system of the invention. Some of the properties include, but are not limited to:

Specific files, such as (music, movies, applications).

Detailed information on certain Internet properties, such as IP address and name registered at ARIN Whois in certain instances.

Geographical location. The geographical location can be determined when a static IP address is used to connect to the computer network. In some instances a dynamic IP address can also be geographically determined if reverse authority has been given or if the carrier (upstream) has registered that information.

Actual content (e.g. Music, applications, movies, text)

Centralized Data Collection Module

Function

The primary function of the centralized network data collection module is to collect metadata from the centralized file-sharing networks associated with the system of the invention.

The Metadata Storage module ingests data from the STL process and does further processing and preparation of the data to assure its conformance to the database schema. Prior to insertion into the database, the data is combined with SQL (Structured Query Language) statements in order to facilitate the data's storage into the database. The formed SQL statements is then passed to a DBAPI (Database Application Programming Interface), in which the database record is then committed to the database.

Webserver

Function

The Presentation module culminates in a subscription based website where participating companies in the aforementioned industries can access the statistical analysis of the data made available by the system of the invention.

Description

The Presentation module uses a webserver connected to a computer network on http port 80 and secured with .htaccess which is a webserver software security module to protect from unauthorized access. The data is displayed using a java applet taking its input via a CGI (Common Gateway Interface) program with embedded SQL queries (Structured Query Language) to make its DB (database) calls. Final presentation of the data from the system of the invention combines statistical data from the Report Generation module with data from the Graphing and Trending module into a format compliant with the display medium (e.g. html, spreadsheet etc.). The results are then presented to the end user.

Advertising Media Data

Function

The Advertising Media Data module facilitates the storage of the advertising content into a storage medium.

Description

The Advertising Media Data module utilizes a database and schema to store the advertising content metadata and assign a global system identification number to each electronic file. When a user requests a file from the “supernode” the configuration gives the administrator of the system of the invention the option to define a “GDR” (Genre Demographic Radius). The GDR, simply put, takes a request and matches it with a number of artist permutations, which based on Boolean logic (true/false), returns a suggested advertisement that based on the system of the invention configurations falls within the parameters of the GDR

Data Retrieval

Function

The Data Retrieval module facilitates the compilation, summation and organization of metadata residing in the GTM database, based upon user requests or queries for certain information.

Description

The Data Retrieval module utilizes embedded SQL queries within the subroutine to retrieve metadata to be parsed by a series of filters. User input can come from a terminal, a Unix based PoS (Point of Sale) terminal, a limited ANSI GUI, Win32 application or via the Presentation module (subscription based website). The system of the invention, based on configuration, can make use of caching servers to insulate the actual database from the outside world (the Internet) and/or provide a third level of fault tolerance.

Report Generation

Function

The Report Generation module takes the metadata from the target file-trading network by the Data Retrieval module and delivers the formatted metadata in textual form.

Description

The Report Generation module parses the data acquired by the Data Retrieval module and generates summarized, tabulated and formatted reports based on user submitted criteria. Example reports that are generated are as follows:

Number of queries per title per a specified period of time.

Queries for a specified electronic file that has been traded.

Amount of queries for a specified electronic file.

Number of queries specified by geographical location.

Number of searches specified by genre for a particular electronic file that has been traded on a computer network.

Geographical dispersion of searches for a particular electronic file.

Geographical dispersion of searches for a particular genre.

Genre dispersion of electronic file title permutations.

Demographical dispersion of electronic file title permutations.

Searches for an electronic file using a global system identification number.

Yes or No, has an electronic file been traded?

Graphic Generation

Function

The Graphic Generation module takes statistical data from the Data Retrieval module and generates a graphical representation of the data.

Description

The Graphic Generation module takes statistical data and generates graphical representations of that data in the form of a graph or chart. The graphical components are public assets that can be accessed via the Presentation module or Win32 module or PoS module and are made available to the caching server module if implemented. Flexibility is provided not by a concrete class, but by a java interface. The Graphic Generation module is responsible for generating graphics in the form of JPEG and GIF formats.

Collection System

Data Collection Plug-in

Function

The Data Collection plug-in is the interface between the core software and the File Trading network. This plug-in handles all communication(s) with the target network(s) needed to accumulate the file trading metadata for the system of the invention. Since various file-trading networks may utilize different protocols, the architecture component described here is based on a per-network “plug-in” to the system of the invention. Tailored for use on each specific computer network, the “plug-in” style architecture of the system of the invention establishes that there can be one system for all target computer networks.

Description

Authentication

The authentication module initiates the connection to the target file-trading computer network based on available authentication protocols, and then makes available the open connection as a “FILE_HANDLE” to the “Session Handler” once a “handshake” with the target computer network is completed.

Session Handler

The Session Handler, simply put, handles the setup and teardown of connections (forking is included) between the Data Collection module and the target file-trading computer network. The Session Handler is where multiple instances of the process of the system of the invention are created and/or terminated by a “KILL” or “OR_DIE” statement.

Data Collection

The Data Collection module receives the search criteria from the database. By making a query to the database for a random file title for example, “The Beatles”, a list of computer users local to that target file-trading computer network who have that file, would be returned to the Data Collection module and stored in the heap as an array, then individual variables can be created from the computer users who make up that string literal and a random and a songlist is compiled based on the total number of songs of the total number of users who have those file titles and the process begins again.

Parsing Module

The Parsing module is a “quick check” for subversive content, such as “buffer overflow”, permutative file titles and/or file extensions that are not of interest to the system administrator of the system of the invention. Qualification before presentation to the schema should prevent “bottle-necking” or overload of a module. The Parsing module loads the users playlist into the heap by loading it as a “FILE_HANDLE” where it is checked by Boolean logic for database schema compliance.

Core Module

Function

The Core Module encompasses all the data collection functionality of the system of the invention that is not platform, database or network specific.

Description

Format Processor

The Format Processor module receives parsed metadata from the Parsing module and loads it as a variable so it can be checked by algorithm for integrity. The Format Processor module of the system of the invention then passes metadata in the form of geographic or demographic relations to optimize operations and to use disk space effectively.

Storage Module

The Storage module takes advertising content from PoS terminals/kiosks Win32 apps and/or the presentation module to the database via its own database schema. The Storage module assigns the following attributes to the advertising content:

Global system identification number.

Location.

Global system identification number for file type.

Content description.

These attributes are passed on as advertising content metadata to the database layer and the database.

Database Layer

Function

The Database layer takes the SQL statements generated the appropriate modules and generates the necessary lower level system calls to commit the data into the database.

Description

The Database Layer utilizes a DBAPI (database application programming interface) to communicate with the database engine. The Database layer handles the following tasks:

Initiation of connection to database engine.

Database authentication and login.

Session management.

Communication of SQL statements to database engine.

Passing of result sets from queries back to the appropriate requesting module(s).

Error reporting on status of database transactions back to the requesting module(s).

The DBAPI provides a programmatic interface to the lower level protocols required to communicate with the database engine. These interfaces are database engine dependent, so the DBAPI utilized is for the specific database engine used (e g. Oracle 9i, Sybase, MySQL, MSQL, etc.).

Storage Layer

Function

The Storage Layer is a programmatic interface to the Data Warehouse.

Description

The Storage Layer creates a programmatic interface to facilitate the storage and retrieval of advertising assets from the advertising content database utilizing the appropriate network protocols to facilitate the transfer of assets without error. The Storage Layer performs the following tasks:

Initiation and termination of socket connections to the advertising content database.

Authentication and login (if required by a particular file transfer protocol).

Managing source/destination of asset to be stored/retrieved.

Asset transfer verification.

Transfer completion acknowledgment to invoking module.

Removal of assets as required.

The Storage Layer utilizes different network and transport protocols (e.g. NFS, FTP SFTP, RCP, etc.) dependent upon the requirements of a particular deployment configuration.

Data Retrieval

GTM Database

Function

The system of the invention stores information on computer network properties, more specifically information about the trading of electronic files over a computer network.

Description

The Database contains the metadata acquired by the Data Collection and Content Acquisition processes, including but not limited to:

Logged searches

Logged permutations

IP address (when available)

Logged asset locations

Content ID's

Defined content types

The data stored in the system of the invention's Database is accessed through the Database Layer.

Database Layer

Function

The Database layer takes the SQL statements generated the appropriate modules and generates the necessary lower level system calls to commit the data into the database.

Description

The Database Layer utilizes a DBAPI (database application programming interface) to communicate with the database engine. The Database layer handles the following tasks:

Initiation of connection to database engine.

Database authentication and login.

Session management.

Communication of SQL statements to database engine.

Passing of result sets from queries back to the appropriate requesting module(s).

Error reporting on status of database transactions back to the requesting module(s).

The DBAPI provides a programmatic interface to the lower level protocols required to communicate with the database engine. These interfaces are database engine dependent, so the DBAPI utilized is for the specific database engine used (e.g. Oracle 9i, Sybase, MySQL, MSQL, etc.).

Subscription Website

Function

The Subscription Website module of the system of the invention is where the end user of the system of the invention can log-in with a username and password to generate charts or lists based on his/her specific needs for information on file-trading on the computer file-trading networks. The data is made available via the Database Layer.

Description

The Subscription Website database provides data to the end user like:

File trader usernames

File trader playlists

File trader geographical location

Demographic breakdown by genre

Subscription expiration date

Subset criteria

Global system identification number

The subscriber username and encrypted password are utilized for authentication to the Data Retrieval module.

User Verification

Function

The User Verification module handles authentication of the end user to the DRS of the system of the invention.

Description

The User Verification module retrieves from the subscriber their subscription credentials via the User Input component over a secure transport mechanism (e.g. SSL). The User Verification component then checks the information against predefined subsets stored in the Subscriber Database. If the credentials received match the ones stored, the subscriber is then considered authenticated. A successful authentication attempt causes a notification to be sent to the Subscription and Limit Verification component and further processing of end customer input continues.

Subscription and Limit Verification

Function

The Subscription and Limit Verification module checks and enforces subscription limits imposed upon subscribers and is commonly referred to as a “kill ring”.

Description

The Subscription and Limit Verification module communicates with the Subscriber Database through the Database Layer. After the subscriber has been authenticated and verified through the User Verification module, the subscription status is then checked against the Subscriber database. If the subscription has not expired, or has not reached other defined usage-based limits, then the subscriber is allowed to continue with the querying process. If the subscription is limited to a specific type of query or limited to a specific subset of metadata, then those constraints are passed to the Query Engine.

Query Engine

Function

The Query Engine component facilitates the creation of an SQL query within the defined constraints to be submitted to the Query Processor.

Description

The Query Engine processes user input and subscription limit parameters to generate a valid query against the metadata in the GTM database. The resulting query is then formatted into an SQL query statement that is subsequently passed on to the Query Processor.

Query Processor

Function

The Query Processor module of the system of the invention processes the SQL statement generated by the Query Engine.

Description

The Query Processor receives an SQL statement from the Query Engine and then submits the query to the Database Engine through the Database Layer. The result subset(s) returned by the Database Engine are then passed on to the Report and Graphing Generation modules of the system of the invention.

Report Generation

Function

The Report Generation module takes the data passed to it from the Query Processor and generates textual reports based upon said data.

Description

The Report Generation module processes the data passed to it from the Query Processor and consolidates, summarizes and formats the data into a textual “report” for further processing by the Trending and Graph Generator and/or the Presentation Processor. These reports are generated from predefined and/or end customer specified templates.

Graphic Generation

Function

The Graphic Generation module creates graphical representations of result sets passed to it from the Query Processor.

Description

The Graphic Generation module takes statistical and absolute information in textual form from the Report Generation module and generates graphical representations of said statistics. The information is then parsed and passed on to a graphics library (e.g. MRTG) to be rendered into a single or multiple images (e.g. jpeg, gif) as required.

Presentation Module

Function

The Presentation module of the system of the invention takes processed metadata from the Report and Graphic Generation modules and processes the data into a presentable form.

Description

The Presentation Module takes graphs and reports and combines them into a final formatted form based on predefined and/or end customer specified templates and the final medium for delivery (eg. HTML, spreadsheet, etc.). The resultant data is then passed on to the Web Server for delivery to the end customer.

User Input

Function

The User Input component functions as the method to acquire input from the end customer and pass said input to other components as required.

Description

The User Input component querys the end customer, intakes end customer input, checks for validity, formats and then passes said input on to the calling component.

Web Server

Function

The Web Server functions as the method of communication to receive input and deliver output to/from the end customer.

Description

The Web Server handles all communication with the end user utilizing the HTTP (Hypertext Transfer Protocol) over the Internet.

Future Software Architecture

In an effort to provide a flexible and easily maintainable implementation, the architecture is split into several layers as opposed to being monolithic. This approach provides modularity of components greatly reducing development time, effort and cost for future revisions.

The implementation's modular design provides flexibility for the addition of new functionality and support of new networks and their protocols as they emerge. All that is required to add support for a new file-trading network and its associated protocols is the development of a new protocol handler that is then “plugged-in” to the existing component framework. This approach enables the GTM system's functionality to be expanded quickly and easily to meet changing requirements.

The GTM system implementation uses the ACE C++ classes and frameworks for efficient event demultiplexing and method dispatching. The implementation utilizes various design patterns to decouple pieces of software to allow easy reuse of existing components.

The Reactor and Connector framework from the ACE C++ toolkit provides us with tested and robust event handling. The Reactor framework allows the registration of concrete event handlers and the invocation of their respective methods when events are sent to the Reactor. The Reactor framework then demultiplexes the actual event handling logic from the logic associated with handling a particular event.

The Connector framework decouples peer initialization from the action associated once the peer has successfully connected. This gives us great flexibility in choosing a particular connection strategy for differing network requirements.

The Future Framework Layer

The framework provides an “inversion of control”, otherwise known as the Hollywood principle—“don't call us, we'll call you.” This layer allows defined, concrete classes to be registered, and to be sent notifications when certain events of interest occur (Diagram 4).

The Connector framework is responsible for creating, activating and connecting the GTM_Session to the particular remote host. If we issue an asynchronous connection using non-blocking I/O, our connect() call returns immediately, and once the connection has completed, a notification is received.

The Reactor framework allows a concrete class of Event_Handler hierarchy to register with a Reactor, and wait for events such as input, or output to occur. When such an event is triggered, GTM_Session receives a notification and forwards that notification via its Implementation pointer. The Implementation pointer points to a certain concrete class tailored for the specific protocol. This layer allows the implementation to be extremely flexible when designing strategies for connection establishment (synchronous/asynchronous), and event notification and handling:

The Future Application Layer

We create concrete class GTM_Session that receives callbacks from the Framework Layer (Diagram 5) upon the arrival of certain events such as I/O, Timer, Signal, etc.

To ensure flexibility and easy integration of new file trading networks into the architecture. The GTM_Session maintains a pointer to the actual Implementation of a particular session. That Implementation is for a Napster network, a Gnutella network, Music City, or other existing or emerging networks.

By maintaining two class hierarchies, those that are derived on the GTM_Session, and those that are derived from the GTM_Session_Impl allows the incorporation of new and evolving file trading service networks as “plug-ins” either statically at compile time or dynamically at runtime.

Peer-to-Peer Protocol Handler Implementation

Peer-to-Peer Protocol Specifications

A Peer-to-peer network consists of “nodes” in which connected peers act as both a client, and a server called a “servant”. For a partial list of networks, servants and clients, see Addendum A. In order to connect to a network, an IP address of any host that is currency connected to the network must be obtained.

Once a servant has successfully connected to the network, it acts as a server (to satisfy requests), and a client (to make requests). If the servant receives a search query, and wishes to fulfill it, it sends a packet indicating that it has the requested data, at which point the peer transfers the data over HTTP port 80. The servant also queries for specific content, or pass requests over to another sever.

Peer-to-Peer Plug-in Protocol Handler Implementation

A Peer-to-peer protocol handler class Handler_Impl implements various functionality dealing with the specific nature of this protocol, in this case a loosely distributed peer-to-peer protocol (Diagram 6). We first need to obtain an IP address of a host currently residing on the network. Upon the initial connection handshake, the connected peer states its inability to service our connection, or allows a connection to it.

Upon a successful connection the system of the invention is able to watch search requests in real-time, since they are passed on to the system from other peers. The routing of packets is done using a TTL (Time To Live) parameter. Once a packet is passed on from one peer to another, the TTL field is decremented to ensure packets are expired on the network. Thus, this loose distributed architecture allows the system of the invention to act as a listener for requests made within its TTL radius. The system then listens for search requests, and the connection of new hosts to which it can connect. Upon getting a search request, the system logs into the GTM database, using a transparent thin DB (Database) API (Application Programmers Interface).

Middle Tier Software (Core)

The middle tier software is responsible for taking the fetched data, optionally converting it into another format and storing it. Since data from multiple “collectors” need to be processed and stored by the core software and hardware, performance and the minimization of overhead is important to insure that the data will flow unimpeded.

The system of the invention utilizes a thin DBI API for:

Encapsulations of requests

Encapsulations of responses

Error handling

The advantages of using an interface are uniformity and flexibility and that different database engines are loaded at runtime, as opposed to just compile time. We are initially using the MySQL database engine for storage of the metadata. MySQL is an open source licensed SQL compliant database package. At this writing, MySQL supports a full subset of the SQL92 spec, with very limited support for sub queries, and no support for transactions and rollbacks. However, it is still an extremely capable engine and is more than suitable for our needs.

Database SQL Schemas

Design of an efficient schema is crucial for data warehousing and statistical analysis. The schema contains the following tables:

ContentTable

ContentID

Type

Size

UserTable

UserID

IP

Handle

The Oracle Database

The GTM system uses Oracle 9i information server as the database engine. Oracle was chosen for its unmatched performance on the Solaris 2.x platform

Sun Microsystems F6800 Database Server

Sun Microsystems™ hardware was chosen because of its flexibility, scalability and because of the unique features of the Sun F6800 server, including the support of logical partitions (multiple virtual domains) that enable multiple instances of the operating system and applications to run on the same physical platform. This enables process and OS fault tolerance.

EMC Storage Server

The EMC storage server provides solid reliability and impressive fault tolerance. It supports Raid 0,1,5,0+1, etc., and represents a storage environment of 100TB when configured in the maximum configuration. EMC provides excellent 24×7 “lights out” monitoring and on site service, and their technicians are dispatched to remedy any problems, most of the time before the customer perceives any symptoms or experiences any problem

Glossary

ACE C++ class—a class in the ACE C++ toolkit

ACE C++ framework—a group of classes within the ACE C++ toolkit for event handling

ACE C++ toolkit—a group of utility classes and templates that can be used as a framework to recreate applications

ACE message block—a block of data used to pass event data within the ACE C++ framework

ASCII character—a standardized method to represent written characters within an application

concurrency framework—a framework enabling the concurrent execution of multiple functions

connector framework—a framework for establishing, maintaining and disconnecting network connections

crawling—the process of traversing a network to collect data

data mining—the process of extracting specific data from a larger collection of data

data warehouse—the repository for all data collected

database engine—an instance of a relational database application (qv)

database schema—a structure defining the method storing data and their relationships in a relational database

DBI API—Database Interface Application Programming Interface

event demultiplexing—the process of extracting a single event from an event message

HTTP port 80—the specific port used for the hypertext transfer protocol

implementation pointer—a pointer to a particular implementation of a class

IO handler—a subroutine for handling input and output operations

IP address—a string of numbers used to address computers on the Internet

ISO character entries—international standards organization

magic number—a file identifier to indicate file type

MD5 checksum—a 128-bit fingerprint to verify the integrity of a file

metadata—a subset of data which describes a larger set of data

method dispatching—the process of invoking subroutines

non-blocking I/O—a method of forming input/output operations asynchronously

OSI protocol stack—a standard representation of network layers

packet—a small piece of information

plug-in—an interchangeable subroutine

programmatic interface—a method to interface to an application via computer programming language

reactor framework—an event handling framework from the ACE C++ toolkit

recommendation engine—a means of establishing appropriate alternatives to a request for a file

relational database—an application for the storage and management of data utilizing relationships for retrieval

rollback—the process of removing recently committed data from a relational database

SAP—service access point. The location and method in which an application connects to a network

SQL 92—a standard for the syntax of Structured Query Language

SQL query—a query written in Structured Query Language

subset criteria—The criteria which governs the scope of data that can be retrieved from a database

TCP sockets—a connection-based IP protocol (transport control protocol)

transaction—a group of SQL statements

TTL field—time to live (the maximum number of hops that a packet of data will make)

UDP sockets—a connectionless-based IP protocol (user datagram protocol)

Addendum A

File Sharing Networks

Audio Galaxy

Both software (satellite) to search user collections at their own machines and a web based search through user's personal online collections, which resides on the Audio Galaxy servers.

Platforms: Windows 95/98/ME, Windows NT, Windows 2000, Linux, Macintosh, Web-based

Blubster

Blubster is a peer-to-peer network with a new private protocol that works without a central server. Once the user's client program connects with another client they're able to search and download Mp3 music files from the entire network of users. The first version features an easy to use interface enabling quick searches, fast downloads and cache files at several sources.

Platforms: Windows 95/98/ME, Windows NT, Windows 2000, Unix

BuddyShare

Has its own network, offers the ability to resume downloads and has an integrated chat client.

Platforms: Windows 95/98/ME, Windows NT, Windows 2000

Carracho

The Carracho Client enables users to use the services provided by a Carracho Server. Once connected to a server, users can meet new friends in chat rooms, discuss ideas in newsgroups and simultaneously download the latest updates for software without switching between different applications. All useful features from IRC, FTP and Usenet programs like multi-threaded news, real-time conferences, moderated chat rooms, drag-n-drop file upload/download etc. are integrated. Additionally Carracho Client allows users to resume downloads, send private personal messages and access all functions needed by server administrators from a single window.

Platforms: Macintosh, other platforms planned

Direct Connect

Direct Connect allows users to share multiple directories from their local and mapped disks with other users over a TCP/IP network. All users' shared files are available to all other users; no passwords are required. Direct Connect provides integrated searching, graphical navigation of files, and public and private chatting.

Platforms: Windows 95/98/ME, Windows NT, Windows 2000

eDonkey 2000

eDonkey 2000 is a multi platform file sharing tool with its own network. It can find any type of file; resume downloads, and gets one file from different sources simultaneously and has many more advanced features.

Platforms: Windows 95/98/ME, Windows NT, Windows 2000, Linux, Macintosh

File Rogue

File Rogue allows users to create a personal “Catalogue” of files that they wish to share with other members of the File Rogue Community. This list is uploaded to the “Global Catalogue” on the File Rogue Server whenever they launch the application. Users then can perform searches of the Global Catalogue, or browse through categories, and select the files they wish to download.

Platforms: Windows 95/98/ME, Windows NT, Windows 2000, Linux, Unix, Macintosh

Filemaze

Filemaze Direct Downloads is a free file-sharing network. It allows users to share their files with other people and search then download files that others on the network are sharing.

Platforms: Windows 95/98/ME, Windows NT, Windows 2000, Unix

File Spree

The purpose of File Spree is to swap files, using a secured method and without using blind links, advertisements, or having to search a million web sites just for one thing. The network of servers is totally decentralized, requiring users to host the servers, which allows for faster connections, downloads, and easier access to files.

Platforms: Windows 95/98/ME, Windows NT, Windows 2000, Unix

Filetopia

Another tool with it's own sharing networks but offering good security and levels of sharing. Has integrated email and instant messaging.

Platforms: Windows 95/98/ME, Windows NT

Flipr

FLIPR is peer-to-peer file-sharing software that provides quality digital music files while accurately compensating copyright holders.

Platforms: Windows 95/98/ME, Windows NT, Windows 2000, Unix, Macintosh

Freenet

Freenet is a large-scale peer-to-peer network which pools the power of member computers around the world to create a massive virtual information store open to anyone to freely publish or view information of all kinds.

Platforms: Windows 95/98/ME, Windows NT, Windows 2000, Linux, Unix

Gnutella

Peer-to-peer client software based on the original Gnutella client written by Winamp's Justin Frankel.

Platforms: Windows 95/98/ME, Windows NT, Windows 2000, Linux, Unix, FreeBSD, Macintosh, Java

Gnutmeg

Gnutmeg is a peer-to-peer distributed file sharing system not unlike Gnutella. It is similar to Napster, but there is no central server. The reference implementation is in Java 1.1 and has a simple command line interface, and uses regular expressions.

Platforms: Unix, Java

Heavy Mole

Heavy Mole is a file-sharing tool that takes the best features from Gnutella, Napster and Hotline and puts it in one package.

Platforms: Linux, Unix

Hotline

Hotline Connect is a suite of two free applications that enables Internet users to communicate and share files and information. Hotline Connect enables users to easily create a personal interactive Internet community with real time chat, conferencing, messaging, data warehousing, file transfer and streaming capabilities.

Platforms: Windows 95/98/ME, Windows NT, Windows 2000, Unix, Macintosh

iMesh

iMesh is another file sharing tool with its own sharing network. They offer many features including animated skins.

Platforms: Windows 95/98/ME, Windows NT, Windows 2000

INoize

INoize is music sharing software with its own network that organizes files by artist, Album and Title.

Platforms: Windows 95/98/ME, Windows NT, Windows 2000, Linux

Jungle Monkey

Jungle Monkey is a channel-based file-sharing tool for Unix with integrated chat functionality utilizing its own network/protocol.

Platforms: Unix, Windows client in development

KaZaa Media Desktop

KaZaa is another all-format peer-to-peer file sharing tool with all the usual features and its own network.

Platforms: Windows 95/98/ME, Windows NT, Windows 2000, Web-based

Konspire

Konspire is a Java-based file shareing tool with its own network.

Platforms: Java

OpenNap

OpenNap extends the Napster protocol to allow sharing of any media type, and the ability to link servers together. Many clients support this protocol.

Mojo Nation

Mojo Nation combines the flexibility of the marketplace with a secure “swarm distribution” mechanism to go far beyond any current file shareing system by providing high-speed downloads that run from multiple peers in parallel. The Mojo Nation technology is an efficient, massively scalable and secure toolkit for distributors and consumers of digital content.

Platforms: Windows 95/98/ME, Windows NT, Windows 2000, Linux, FreeBSD

Morpheus

Morpheus is a full-featured P2P file-sharing application that allows users to search for all types of digital media across the MusicCity Network. Morpheus is neither central server-based, like-Napster, nor based on the Gnutella file-sharing protocol. The program uses a proprietary peer-to-peer protocol to share files among users on the network.

Platforms: Windows 95/98/ME, Windows NT, Windows 2000, Unix

Mp3 Startpagina

A Dutch portal with multiple mp3 resources.

Platforms: Web-based

MP3 World

This is another Dutch mp3 portal.

Platforms: Web-based

MP3.com

One of the most complete mp3 portals, which also offers free mp3 music by mostly unknown artists.

Platforms: Web-based

Openblue Fileshare

Openblue Fileshare is another Java-based tool with its own network.

Platforms: Java

OutLoud.nl

A Dutch community/news style website that offers a number of free mp3's, mostly unknown artists.

Platforms: Web-based

RiffShare

RiffShare is a jukebox application that allows sharing with other users.

Platforms: Windows 95/98/ME, Windows NT, Windows 2000

RighteousMP3

RighteousMP3 is a Napster like program that compensates copyright holders for user's downloads and offers statistical information to the record labels, but is completely free for users.

Platforms: Windows 95/98/ME, Windows NT, Windows 2000, Unix, Macintosh

Scour Exchange

This software is currently being redesigned and made ‘legal’ with a new version on the way soon.

Platforms: Windows 95/98/ME, Windows NT, Windows 2000

Servent

Servent is a windows based tool with its own network and the ability to share all types of files.

Platforms: Windows 95/98/ME, Windows NT, Windows 2000

SongSpy

A peer-to-peer software tool with its own network and many Napster-like features, like a built-in mp3 player.

Platforms: Windows 95/98/ME, Windows NT, Windows 2000

Soulseek

Soulseek is a communication and file-sharing system. All activity in Soulseek revolves around a sophisticated chat rooms system that arranges rooms on a hierarchical topic tree, with the ability for new rooms to be created. It offers folder-based file sharing, which allows for more convenient browsing and downloading. It also offers fine-grained control over file sharing, with the ability to restrict access to a select list of users, as well as the ability to disallow access to specific users.

Platforms: Windows 95/98/ME, Windows NT, Windows 2000, Windows XP

Splooge

Splooge is a file-sharing tool for use over the Internet for people who have access to the Splooge central server. Users can share files of any type with anyone in the world as long as they have unrestricted use of the Internet.

Platforms: Windows 95/98/ME, Windows NT, Windows 2000, Unix

Swapnut

SwapNut's advanced features include upload limits, an extensive and well-established file sharing network and cross-platform compatibility.

Platforms: Windows 95/98/ME, Windows NT, Windows 2000, Unix

Tripnosis

Tripnosis allows users to share their files with others (restricted or worldwide) through the software and/or over the web. It has its own network and the ability to resume downloads.

Platforms: Windows 95/98/ME, Windows NT, Windows 2000

UdoRadio

UdoRadio was created by a small group of people that were generally dissatisfied with streaming and download audio sites on the web. Users program what they want to listen to and then UdoRadio streams the content to them.

Platforms: Unix, Web-based

WideSource

WideSource is an P2P search engine having its own network and many features

Platforms: Windows 95/98/ME, Windows NT, Windows 2000

Wippit

Wippit is one of the world's first legitimate p2p music subscription services with a wide range of recordings for users to download to their pc or media terminal. Also offered are mobile services and ring tones.

Platforms: Windows 95/98/ME, Windows NT, Windows 2000

File Sharing Clients

2 Find MP3

2 Find MP3 is another example MetaCrawler software that searches both http and ftp and verifies the results. It is compatible with most ftp software.

Platforms: Windows 95/98/ME, Windows NT, Windows 2000/XP

Abe's MP3 Finder

Abe's MP3 Finder searches Gnutella, Scour Exchange, and ftp servers simultaneously.

Platforms: Windows 95/98/ME, Windows NT, Windows 2000

Agent MP3

Agent MP3 is a tool to search for mp3's on Usenet.

Platforms: Windows 95/98/ME, Windows NT, Windows 2000

AudioGnome

AudioGnome is peer-to-peer client software that allows users to connect to multiple Napster based servers at the same time.

Platforms: Windows 95/98/ME

AudioLocator

AudioLocator searches for mp3's on ftp servers.

Platforms: Windows 95/98/ME, Windows NT, Windows 2000

BearShare

BearShare is a Windows file sharing built on Gnutella technology. BearShare provides a simple, easy to use interface combined with a powerful connection and search engine that puts thousands of different files in easy reach.

Platforms: Windows 95/98/ME, Windows NT, Windows 2000

Bodetella

A Gnutella client with features like Download Resume, Auto-Retry-Resume, Download Queuing, Queue and Throttling Auto Host File Update

Platforms: Windows 95/98/ME, Windows NT, Windows 2000

ComTry MP3 Downloader

ComTry MP3 Downloader helps user to find their favorite MP3 files on the Internet. It searches for the most reliable locations and lets users easily download the songs they chose.

Platforms: Windows 95/98/ME, Windows NT, Windows 2000

Espra

Espra's competitive edge over other file-sharing applications comprises its use of the 3rd generation network architecture, Freenet as the medium through which users share their files. Freenet uses a decentralized architecture and has no central point of failure.

Platforms: Windows 95/98/ME, Windows NT, Windows 2000, Unix

FileCat

FileCat is a Multimedia management and search tool with extra support for images and mp3's. It requires IE5.

Platforms: Windows 95/98/ME, Windows NT, Windows 2000, Unix

FileNavigator

Software that connects to the Opennap and Gnutella networks and allows for the download of any type of file. It also has the ability to resume downloads.

Platforms: Windows 95/98/ME, Windows NT, Windows 2000

Findsongs/Palavista

A MetaCrawling web-based search that looks to ftp servers for its results

Platforms: Web-based

FirstPeer

FirstPeer Transponder solves the problem of having to hunt for the people or the resources users are looking for. Rather than randomly connecting to the first available host on the Gnutella network, user can now connect to their friends and groups of users sharing similar interests. Instead of searching a large pool of resources, users are now able to refine their searches to those that match their interests with the use of groups.

Platforms: Java

Freegle

Freegle is a web-based search that is still under construction that searches Freenet.

Platforms: Unix, Web-based

Frost

Frost is a Java-based Freenet Client

Platforms: Unix, Java

Furi

Furi is a Gnutella protocol-compatible Java program that can participate in the Gnutella network. It is a full version program with an easy to use GUI interface that can perform most of the tasks of a Gnutella servant.

Platforms: Macintosh

Gnotella

Gnotella is clone of Gnutella, a distributed real time search and file-sharing program. Gnotella is for the Win32 environment, and offers extra benefits such as multiple searches, improved filtering/spam protection, bandwidth monitoring, enhanced statistics, upload throttling, and skinning, as well as more.

Platforms: Windows 95/98/ME, Windows NT, Windows 2000

Gnucleus

This is a Gnutella clone for windows with advanced features and security.

Platforms: Windows 95/98/ME, Windows NT, Windows 2000

Gnut

Gnut is a command-line client that implements the Gnutella protocol. It supports all features available in the original Nullsoft client, as well as many others. Bandwidth limiting, sorting of results, and regular expression searching are among the list. It compiles and runs on a wide range of POSIX compliant (and not so compliant) systems including: SunOS, Linux, FreeBSD, HP-UX, and Win32.

Platforms: Windows NT, Linux, Unix, and FreeBSD

Gnute

Gnute is a web based search engine that allows users to search the Internet for mp3s.

Platforms: Web-based

Grokster

Grokster is the latest generation of file sharing software. The Grokster generation of file sharing presents peer to peer, fast and detailed searches, no incomplete or failed downloads, auto resume, a fast network, file previews, and the downloading of any type of file. Grokster utilizes the same networks as Kazaa and Morpheus.

Platforms: Windows 95/98/ME, Windows NT, Windows 2000, Unix

GTK-Gnutella

GTK-Gnutella is a clone of Gnutella, which needs GTK+(1.2 or above). It is currently developed and tested under Linux (Debian 2.2). It is known to run at least on Linux and FreeBSD (on 80x86 machines). It is released under the GNU Public License (GPL).

Platforms: Linux, Unix, FreeBSD

Hagelslag

Hagelslag is an implementation of Gnutella. The main goals for this implementation are flexibility, stability, and performance. The development of Hagelslag was primarily aimed at i386 machines running Linux version 0.8. FreeBSD is supported as well

Platforms: Linux, FreeBSD

iAssimilator

The user is allowed to easily share any type of file—MP3s, Pictures, Games, Documents, etc. with other users on the Internet. It uses Gnutella and Napster networks.

Platforms: Windows 95/98/ME, Windows NT, Windows 2000

Iwan 's MP3 Finder

A freeware program enabling users to search up to ten mp3 search engines simultaneously, or display the results of up to four mp3 search engines on one screen.

Platforms: Windows 95/98/ME, Windows NT, Windows 2000

LimeWire

LimeWire is a multi-platform Gnutella client with features like auto-connect; browse host, multiple search, upload throttling, connection quality control, library management and sophisticated filtering.

Platforms: Windows 95/98/ME, Windows NT, Windows 2000, Macintosh, Java

Mactella

Mactella is the Mac version of Gnutella, an open-source file-sharing network that allows users to exchange an assortment of file formats with other users. It can operate on any port and has no centralized server. This program is capable of transferring any type of file that users put online, including ZIP, MPEG, ASF, MOV, QT, HQX, EXE, JAR, and SIT.

Platforms: Macintosh

Madster

Integrates with AOL Instant Messenger and allows users to search Napster, Gnutella, AOL, and MSN networks for files.

Platforms: Windows 95/98/ME, Windows NT, Windows 2000, Macintosh

MediaGrab!

MediaGrab! is used for finding and downloading media files from the web, Usenet, and more. Instead of using a web page search engine to search to find multimedia files, users can use MediaGrab! to locate files by subject, author, song name, band name, etc.

Platforms: Windows 95/98/ME, Windows NT, Windows 2000

MP3 Easy

MP3 Easy allows users to search for songs by title and artist and has functionalities like upload/download ratios.

Platforms: Windows 95/98/ME, Windows NT, Windows 2000, Unix

MP3 Groupie

MP3 Groupie is an mp3 searching application for locating mp3 files on Usenet.

Platforms: Windows 95/98/ME, Windows NT, Windows 2000

MP3 Rage

MP3 Rage is a file search application. The user can search for and download thousands of MP3's from the Internet using the Napster music sharing system and the Gnutella file sharing system, edit ID3 tags, analyze MP3's and adjust their sound volume automatically to play at similar levels, export MP3 files to AIFF format for burning CD's, play MP3 files, catalog, organize, rename, find, and change MP3 files and their ID3 tags.

Platforms: Macintosh

MP3Explorer

MP3 Explorer is a windows application that can search/play/download mp3 files from Mp3.com. Users can also transfer CD's to a mymp3.com account and manage their mp3.com play lists directly from within the program. Mp3.com stores hundreds of thousands of mp3 files grouped under different genres. Users can easily subscribe to mymp3.com directly from the program.

Platforms: Windows 95/98/ME, Windows NT, Windows 2000, Unix

NapAmp

NapAmp allows users to connect and download from Napster servers directly from Winamp. NapAmp doesn't support the “Alternative GET” mode yet, meaning that users cannot access Napster clients that are behind a firewall from NapAmp.

Platforms: Windows 95/98/ME, Windows NT, Windows 2000

Napigator

Generates a list of Napster-based networks that are online and how many users are present on the network. When users click on their choice, the Napster software is launched using the network/server selected.

Platforms: Windows 95/98/ME, Windows NT, Windows 2000

Napimx

Napimx is a program made to add Napigator servers into Winmx to have many searches in different servers at once. It has the following advantages: It processes IP addresses instead of server names so users do not have to wait for “resolving host names. It consumes much less RAM than Napigator application.

Platforms: Windows 95/98/ME, Windows NT, Windows 2000

Newtella

Newtella is the new way to share music over the Internet. It combines a focus on music, like Napster, with a decentralized network of users, and is based on the Gnutella protocol. The software is designed to retrieve and exchange only MP3 files. As such, it prevents the unrestricted duplication of viruses and self-executing Trojan horses. If also prevents illicit uses (such as child pornography) of the Gnutella network.

Platforms: Windows 95/98/ME, Windows NT, Windows 2000

N-Tella

N-Tella gives users the ability to get on the network and locate and download files. Utilizes quick and stable networking code with and object-orientated architecture.

Platforms: Windows 95/98/ME, Windows NT, Windows 2000

Ohaha

A file sharing tool that uses all the networks out there (Napster, Gnutella, etc.) and works completely decentralized. It is a plug-in that runs within IE5.

Platforms: Windows 95/98/ME, Windows NT, Windows 2000

SnarfZilla

Snarfzilla is a Napster-like client which operates over Freenet. Users can browse Freenet in an HTML browser, like Fproxy, but securely, without accessing the web in the browser. It differs from Napster and other peer-to-peer clients because of features like; Anonymity, no central server and being attack resistant.

Platforms: Windows 95/98/ME, Windows NT, Windows 2000, Linux, Unix, FreeBSD, Macintosh

SoundCrawler Sound Agent

This is an mp3 searcher with chat, IM, email, calendar and content integration Platforms: Windows 95/98/ME, Windows NT, Windows 2000

Swaptor

Swaptor connects to Gnutella, OpenNap, and FileNavigator. Supports all file types with bandwidth controls and the ability of resuming downloads.

Platforms: Windows 95/98/ME, Windows NT, Windows 2000, Unix

Toadnode

Toadnode is an extensible platform for peer-to-peer (P2P) networks. Its core functionality revolves around the ability to find, retrieve and distribute data among users across multiple networks. It includes an extensible application layer that makes it easy to plug in additional features. Toadnode uses the Gnutella network.

Platforms: Windows 95/98/ME, Windows NT, Windows 2000

WinMP3Locator

WinMP3Locator is a software based Meta crawler

Platforms: Windows 95/98/ME, Windows NT, Windows 2000

WinMp3Locator

WinMP3Locator searches for a song by the user-specified keywords in all popular MP3 search engines. WinMP3Locator can even search for a composition if the user does not know the author or is not sure about exact composition title.

Platforms: Windows 95/98/NE, Windows NT, Windows 2000

WinMX

WinMX is a free file-sharing program that allows users to simultaneously connect to many established networks based on the OpenNap and Napster protocols. WinMX also supports any file type.

Platforms: Windows 95/98/ME, Windows NT, Windows 2000, Unix.

I claim:

1. A method for determining popularity of a movie or song comprising the steps of:
connecting a server to a user's computer having file trading software, via an internet connection;
sending a request from the server to the user's computer, with the request asking for all files contained in one or more playlists associated with the user's computer;
with the server receiving playlist data from the user's computer and recording the internet protocol address from the user's computer;
storing the playlist data in a database;
executing a query of the database to create frequency data indicative the frequency that a particular song or movie was present in a given playlist, to determine the popularity of a given song or movie;
generating a report for multiple geographical areas based on the frequency data;
delivering the report to a subscription based website.

2. A method of delivering advertising content to a computer user comprising the steps of:
storing advertising content in a database and assigning an identification number to each electronic file in the database;
intercepting incoming music, movie, or software file requests and defining a Genre Demographic Radius for that file request,
matching the Genre Demographic Radius with advertising content using Boolean logic, and
electronically returning a demographically appropriate advertisement to the user.
